(19) United States
(12) Patent Application Publication
(10) Pub. No.: US 2022/0090955 A1
(43) Pub. Date: Mar. 24, 2022

(54) SYSTEM AND METHOD FOR MEASURING THE FILLING LEVEL OF A FLUID CONTAINER BY MEANS OF ACOUSTIC WAVES

(71) Applicant: DEHON SAS, Paris (FR)

(72) Inventor: Gérald Anquetil, Beaumont Sur Oise (FR)

(73) Assignee: DEHON SAS, Paris (FR)

(21) Appl. No.: 17/424,467

(22) PCT Filed: Jan. 23, 2020
(86) PCT No.: PCT/EP2020/051570

§ 371 Date: Jul. 20, 2021

(30) Foreign Application Priority Data
Jan. 24, 2019 (FR) 1900623

(51) Int. Cl. G01F 23/296

(52) U.S. Cl. CPC G01F 23/2962; G01F 23/2965

(57) ABSTRACT

Disclosed is a system for measuring the filling level of a container, by means of acoustic waves, the system comprising at least three transducers configured to be positioned at different vertical heights on the outer face of the cylindrical portion of the casing, each transducer being configured to emit, upon receiving a first electric signal, an incident acoustic wave at the outer face of a wall of the casing, and to emit a second electric signal upon receiving a reflected acoustic wave generated by the reflection of the incident acoustic wave on the inner face of the wall, and at least one calculation unit configured to determine, based on the electric signals and physical properties of the monophase fluids, the presence of the first monophase fluid at each vertical height of the transducers.

### TECHNICAL FIELD

The present invention relates to the field of measuring the fill level of a fluid tank, and more precisely to the use of acoustic waves to measure the fill level of a fluid tank. Although the present invention can be used in many fields, it finds a particular application in that of refrigeration or air conditioning type facilities, used, non-restrictively, in the field of fresh and frozen product distribution.

### BACKGROUND

Refrigeration and air conditioning type systems are indeed supplied with fluids that are stored in part in pressurized tanks, which are generally opaque and closed. FIG. 1 thus represents a cylindrical tank 100 with a vertical axis X100, comprising an envelope 102 and storing a liquid L and a gas G separated by an interface 101 defining the fill level N_{R} of the tank 100 with liquid L. This fill level N_{R} cannot be determined visually.

A system for measuring the liquid fill level of a tank is known in prior art from patent application FR2949559A1, making it possible to give the value of this level instantaneously, whatever the shape of the tank, orientation of the tank (vertical or horizontal) and nature of the liquid it contains, while being reliable and inexpensive. This measurement device comprises a vertically arranged external column connected to the tank through flexible pipes. According to the principle of communicating vessels, the level of the liquid balances at the same height in the external column and in the tank. This measurement device further comprises weighing means holding the external column, in order to measure the weight of the external column as a function of the liquid level. This measurement device also comprises a calculator configured to determine the level of liquid in the external column, especially from the measured weight of the external column, and consequently the fill level of the tank. However, this measurement system requires that the tank comprises an upper port and a lower port so that the tank and the external column are in communication. Furthermore, it is necessary to drain the tank when connecting the external column. Since fluids used in refrigeration or air conditioning type systems are also harmful to the environment and/or health, this draining is also delicate to carry out.

To eliminate these drawbacks, the fill level of a fluid tank can be measured non-intrusively using acoustic waves in the ultrasonic range. This measurement is based on differences in physical properties of acoustic waves propagating in two different single-phase fluids, namely a liquid and a gas, two different liquids, or two different gases. As an example, the speed of propagation of an acoustic wave is higher in liquids than in gases. This measurement additionally uses reflection and refraction of acoustic waves. According to these principles, when an acoustic wave propagating in a first single-phase fluid, called an incident wave, meets an interface with a second single-phase fluid, part of the acoustic wave, called a refracted wave, propagates in the second single-phase fluid and the other part, called a reflected wave, propagates in the reverse sense in the first single-phase fluid. It is considered for the following that the first single-phase fluid is a liquid-phase refrigerant, whose fill level is desired to be known, and that the second single-phase fluid is this gas-phase refrigerant, which corresponds to the most common case.

As illustrated in FIG. 1, a first acoustic wave measurement method is known in prior art from patent application US2012259560A1, which makes it possible to determine the fill level N_{R} of liquid L in a tank 100, regardless of orientation of the tank 100 and nature of the liquid L that it contains. This first method comprises a step of emitting an incident acoustic wave O₁ into the liquid L, from the lower part of the envelope 102 and along the vertical, and a step of receiving a reflected acoustic wave O₂, generated by the reflection of the incident acoustic wave O₁ on the interface 101. These two acoustic waves are respectively emitted and received by piezoelectric transducers 202. The time elapsing between emission of the incident acoustic wave O₁ and reception of the reflected acoustic wave O₂ by the piezoelectric transducers 202, known to the person skilled in the art as the “transit time”, makes it possible to determine the fill level N_{R} of the tank 100. However, the drawback of this method is that it is of low accuracy and can only be used for a tank the lower part of the envelope 102 of which is planar in order to allow the reception of the reflected acoustic wave O₂.

As illustrated in FIG. 2, a second method for measuring the fill level N_{R} of a tank 100, also based on the transit time of acoustic waves, is known from patent application US2016320226A1. Unlike the first method, this second method is implemented by emitting an incident acoustic wave O₁ from the lateral part of the envelope 102 by a first piezoelectric transducer 203, at an angle β with respect to the horizontal and at a height h sufficient for it to propagate in the gas G before reaching the interface 101. The reflected acoustic wave O₂, generated by the reflection of the incident acoustic wave O₁ on the interface 101, is received at the same height h by a second piezoelectric transducer 204. This second method has the advantage that it can be applied to any kind of liquid L and for tanks whose lower part is not planar. However, it has the drawback of being of low accuracy. Moreover, to be reliable, it needs to be applied to a tank 100 with planar side walls. Furthermore, this second method requires that the height h of the piezoelectric transducers 203, 204 is always higher than the fill level N_{R}. This is limiting since the fill level N_{R} is unknown prior to the measurement,

As illustrated in FIG. 3, a third method for measuring the fill level N_{R} of a tank 100 is known from the same patent application US2016320226A1, in turn based on acoustic energy attenuation. Unlike the first two methods, an incident acoustic wave O₁ is emitted by a first piezoelectric transducer 205 so as to propagate vertically in the lateral part of the envelope 102. This incident acoustic wave O₁ is emitted at an emission height hₐ higher than the fill level N_{R} and is received at a reception height h_{b} lower than the fill level N_{R} by a second piezoelectric transducer 206. During its propagation in the envelope 102, the incident acoustic wave O₁ loses part of its amplitude, which is absorbed by the liquid L. If the fill level N_{R} of the tank 100 is high, the amplitude of the incident acoustic wave O₁ decreases more during its propagation than if the fill level N_{R} is small. The amplitude of the wave when received then makes it possible to determine the fill level N_{R} of the tank 100. The drawback of this third method is that it is of low accuracy or reliability. Moreover, it is only applicable to a tank with a vertical axis. Finally, like the second method, it requires that the emission height hₐ and the reception height h_{b} are always respectively lower and higher than the fill level N_{R}, which is unknown before the measurement.

In a similar way, from patent application U.S. Pat. No. 5,755,136A1, there is known the emission of an acoustic wave from a first wall to a second opposite wall in order to measure, on the one hand, the acoustic attenuation over a round trip and, on the other hand, the vibratory response of the first wall. The combined measurements of the acoustic attenuation and the vibratory response allow to determine whether a liquid is present between the first wall and the second wall at the measurement location. Such a method remains complex and time consuming since it requires two independent measurements. Finally, the measurement of acoustic attenuation is inaccurate since the first and second walls are generally not perfectly planar and are far apart.

There is therefore a need for a system and method for measuring the fill level of a fluid tank that is accurate and reliable, independent of the shape and orientation of the tank and independent of the nature of the fluids contained in the tank.

### SUMMARY

The invention relates to an acoustic wave measurement system for measuring the fill level of a tank, said tank storing a first single-phase fluid having first physical properties and a second single-phase fluid having second physical properties, said first physical properties comprising a first density and said second physical properties comprising a second density strictly lower than the first density so that the single-phase fluids are vertically superimposed in the tank, the first single-phase fluid being located in the lower part of the tank, the second single-phase fluid being located in the upper part of the tank, said first single-phase fluid and said second single-phase fluid being separated by a substantially horizontal interface, said tank comprising an envelope extending longitudinally along an axis, the envelope comprising an inner face in contact with the single-phase fluids and an outer face, the envelope comprising a cylindrical median portion.

The measurement system is remarkable in that it comprises:
at least three transducers configured to be positioned at different vertical heights on the outer face of the cylindrical portion of the envelope,
each transducer being configured, on the one hand, to emit, upon receiving a first electric signal, an acoustic wave incident to the outer face of a wall of the envelope and, on the other hand, to emit a second electric signal, upon receiving a reflected acoustic wave corresponding to the reflection of the incident acoustic wave on the inner face of said wall, the reflected acoustic wave having passed only through the wall of the envelope, the second electric signal being a function of the difference in acoustic energy between the incident acoustic wave and the reflected acoustic wave, and
at least one calculation member configured to determine, from the electric signals and physical properties of the single-phase fluids, the presence of the first single-phase fluid at each vertical height of the transducers and to deduce the fill level therefrom.

Advantageously, by virtue of the invention, each transducer makes it possible to verify the presence of the first single-phase fluid at each height by measuring an acoustic attenuation. Advantageously, the use of a plurality of transducers forms a detection scale in order to determine the interface between the single-phase fluids in a discrete manner.

Unlike prior art which teaches to measure acoustic attenuation directly in a fluid, the present invention is directed to an indirect measurement by analyzing the acoustic attenuation of the wall. Advantageously, the applicant has realized that the acoustic attenuation of the wall depends on the presence or absence of fluid on the inner side of the wall. Indeed when an acoustic wave is reflected on any interface, the fluid located on the other side of the interface absorbs part of the energy of the acoustic wave, thereby decreasing its amplitude. By virtue of the invention, the presence of a fluid is detected independently of the cross-sectional area of the tank, which is highly advantageous.

Preferably, the transducers are aligned along a line in a vertical plane. Advantageously, the transducers are connected with each other so as to facilitate installation and wiring thereof.

According to a first aspect, the transducers are aligned along a rectilinear or straight line, in particular, for a vertical tank.

Preferably, the transducers are configured to emit horizontal incident acoustic waves. This advantageously allows for detection by acoustic energy attenuation. Acoustic energy attenuation refers to an attenuation of the amplitude of the acoustic wave or, in other words, its acoustic power.

According to a second aspect, the transducers are aligned along a curved line but in the same vertical plane for a horizontal tank.

Preferably, the calculation member is configured to determine the state of a transducer from the difference in acoustic energy between the emission of the incident acoustic wave O₁ and the reception of the reflected acoustic wave O₂ that it has received.

Preferably, the difference in acoustic energy is determined from the acoustic impedance of the single-phase fluids. Preferably, the measurement system comprises a temperature sensor in order to determine the acoustic impedance to be taken into account, which is a function of the temperature of the fluid.

Preferably, the calculation member is configured to compare electric signals to a database comprising reference acoustic attenuations of the single-phase fluids for said tank to determine the presence of the first single-phase fluid at each vertical height of the transducers. More preferably, the calculation member is configured to compare the difference in acoustic energy at each transducer to a database comprising reference acoustic attenuations of single-phase fluids for said tank.

Preferably, with the calculation member configured to determine, for each transducer, a lower state in the presence of the first single-phase fluid or an upper state in the absence of the first single-phase fluid, the calculation member is configured to determine the height of the interface from the height of the two successive transducers, one of which is in a lower state and the other is in an upper state.

According to one aspect of the invention, the transducers are configured to emit, further to the incident wave, a complementary incident wave in the wall of the envelope of the tank, the trajectory of this complementary incident wave being oriented by a measurement angle (3 with respect to that of the incident acoustic wave so as to generate a complementary reflected acoustic wave that is received by a transducer adjacent to the transducer having emitted the incident waves.

Preferably, the calculation member is configured to measure acoustic attenuation at each transducer to a database comprising reference acoustic attenuations of single-phase fluids for said tank and for said measurement angle β.

The invention also relates to an assembly of a tank and a measurement system as previously set forth.

The invention further relates to an acoustic wave measurement method for measuring the fill level of a tank, implemented by means of the measurement system as previously set forth, the method comprising:
a step of emitting by each transducer an incident acoustic wave to the outer face of a wall of the envelope following the reception of a first electric signal,
a step of receiving an acoustic wave reflected by each transducer generated by the reflection of the incident acoustic wave on the inner face of said wall, the reflected acoustic wave having passed only through the wall of the envelope, the second electric signal being a function of the difference in acoustic energy between the incident acoustic wave and the reflected acoustic wave
a step of determining the presence of the first single-phase fluid at each vertical height of the transducers from the electric signals and the physical properties of the single-phase fluids and
a step of determining the fill level as a function of the presence of the first single-phase fluid at each vertical height of the transducers.

Preferably, the transducers are controlled simultaneously.

Preferably, the incident waves belong to the ultrasonic range and are preferably sinusoidal pulses.

### BRIEF DESCRIPTION OF THE DRAWINGS

The invention will be better understood upon reading the following description, which is given solely by way of example, and referring to the appended drawings given as non-limiting examples, in which identical references are given to similar objects and in which:

FIG. 1 is a schematic representation of a first acoustic wave measurement method for measuring the fill level of a fluid tank according to prior art,

FIG. 2 is a schematic representation of a second acoustic wave measurement method for measuring the fill level of a fluid tank according to prior art,

FIG. 3 is a schematic representation of a third acoustic wave measurement method for measuring the fill level of a fluid tank according to prior art,

FIG. 4 is a schematic representation of the acoustic wave measurement method upon detecting the presence of fluid at several vertical heights for a horizontal tank,

FIG. 5 is a cross-section view of the tank of FIG. 4,

FIGS. 6A and 6B are schematic representations of the incident wave emitted to the outer face of the wall and the wave reflected from the inner face of said wall at several vertical heights,

FIGS. 7 and 8 are close-up schematic representations of an emission of a horizontal incident wave and a complementary incident wave,

FIG. 9 is a schematic representation of the acoustic wave measurement method upon emitting a complementary incident wave,

FIG. 10 is a schematic representation of the acoustic wave measurement method upon detecting the presence of fluid at several vertical heights for a vertical tank, and

FIG. 11 is a schematic representation of the steps of the acoustic wave measurement method for measuring the fill level of a fluid tank.

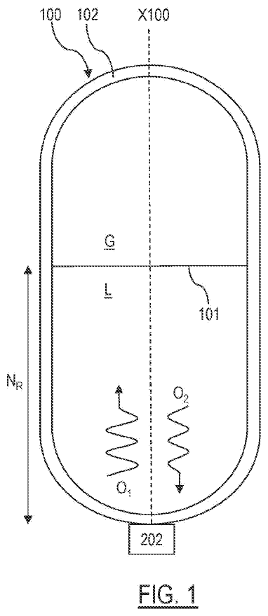

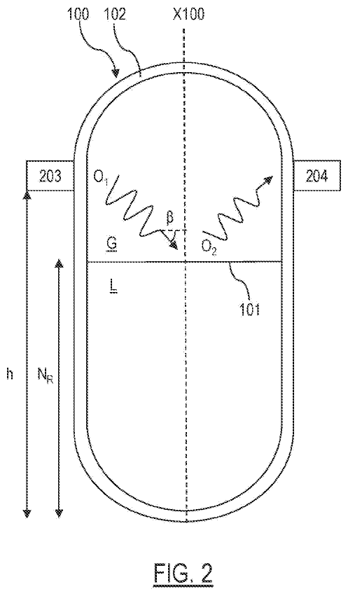

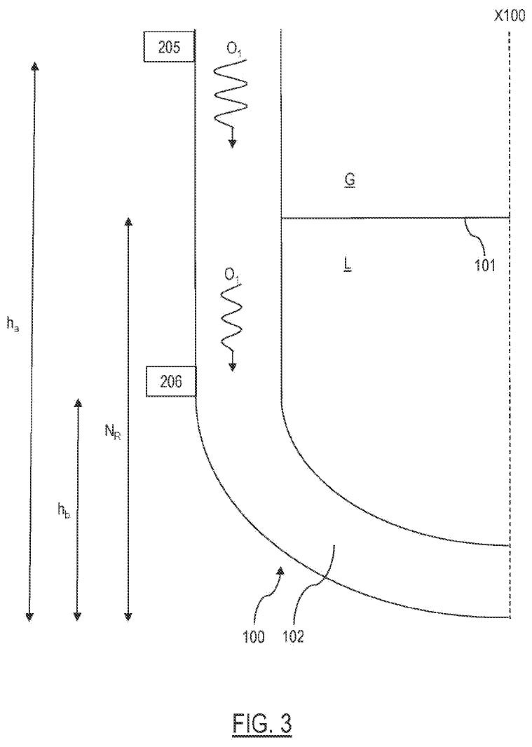

It should be noted that the figures disclose the invention in detail to implement the invention, said figures can of course be used to better define the invention if necessary.

### DETAILED DESCRIPTION

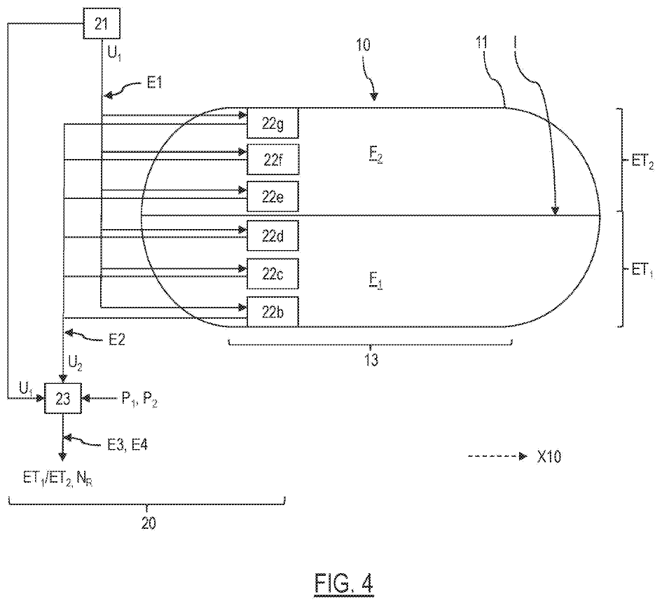

With reference to FIG. 4, an acoustic wave measurement system for measuring the fill level N_{R} of a tank 10 is schematically represented.

In the following, the vertical direction is defined as the direction of the axis of gravity and the horizontal direction as the direction perpendicular to the vertical. The terms “low,” “high,” “upper,” and “lower” are determined with respect to the vertical direction.

As illustrated in FIG. 4, there is represented a tank 10 storing a first single-phase fluid F₁, a liquid phase refrigerant for example, and a second single-phase fluid F₂, in this example gas phase refrigerant, in particular, the same.

The first single-phase fluid F₁ has first physical properties P₁, especially a first density ρ₁, and the second single-phase fluid F₂ has second physical properties P₂, especially a second density ρ₂ strictly lower than the first density ρ₁, so that the first single-phase fluid F₁ is located in the lower part of the tank 10 and the second single-phase fluid F₂ is located in the upper part of the tank 10. The theoretical speeds of propagation V₁, V₂ of an acoustic wave in the single-phase fluids F₁, F₂ are also known. As will be set forth later, the tank 10 further comprises a temperature probe (not represented) so as to determine temperature T₁, T₂ of the fluids F₁, F₂.

As illustrated in FIG. 4, the first single-phase fluid F₁ and the second single-phase fluid F₂ are thus separated by a substantially horizontal interface I. The height of this interface I corresponds to the fill level N_{R} of the tank 10 with the first single-phase fluid F₁. In this example, the first single-phase fluid F₁ and the second single-phase fluid F₂ are respectively a liquid and a gas, but of course they could be in the form of two different gases or even two different liquids.

The tank 10 extends longitudinally along an axis X10 which is, in this first embodiment, horizontal. For the sake of clarity and brevity, a tank having a longitudinal axis extending vertically will be referred hereinafter to as a “vertical tank” and a tank having a longitudinal axis extending horizontally will be referred to as a “horizontal tank”.

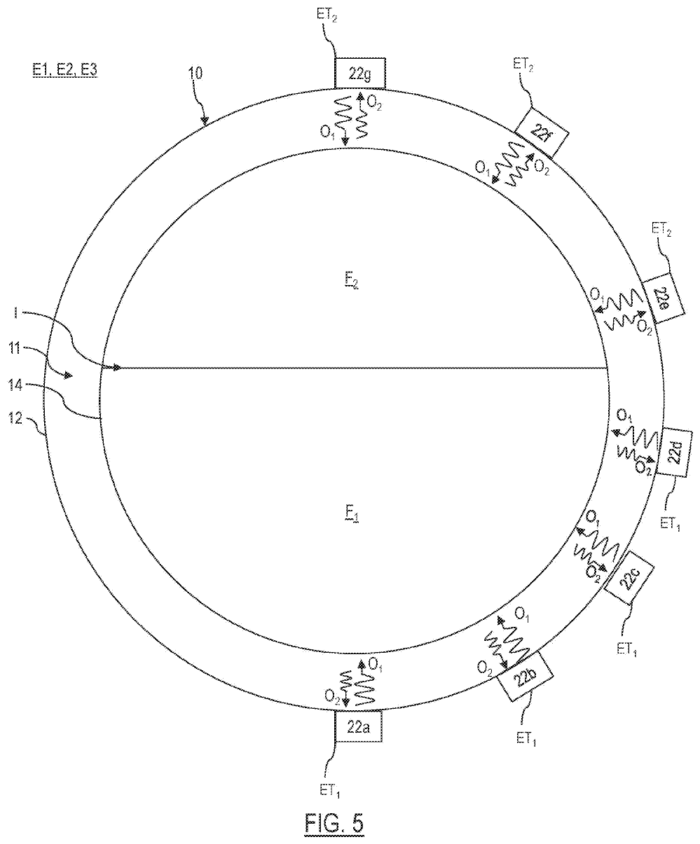

With reference to FIG. 5, the tank 10 comprises an envelope 11 having a wall comprising an inner face 14 in contact with the single-phase fluids F₁, F₂ and an outer face 12 opposite to the inner face 14. The tank 10 comprises two ends and a cylindrical median portion 13 that extends along the axis X10. In the following, a cylindrical median portion 13 having an annular cross sectional area will be set forth, being particularly adapted to distribute pressure forces, but of course it could be different. Such a tank 10 is known to the person skilled in the art and will not be set forth in more detail.

A system for measuring the fill level N_{R} of the tank 10 according to the invention will now be set forth with reference to FIGS. 4 and 5.

In this example, the measurement system 20 comprises a plurality of transducers 22a-22g positioned on the tank 10 at different vertical heights as well as a control member 21 and a calculation member 23 which are connected to the transducers 22a-22g.

Each transducer 22a-22g is configured, on the one hand, to emit, upon receiving a first electric signal U₁, an incident acoustic wave O₁ to the outer face 12 of a wall of the envelope 11 and, on the other hand, to emit a second electric signal U₂, upon receiving a reflected acoustic wave O₂, corresponding to the reflection of the incident acoustic wave O₁ on the inner face 14 of said wall, the reflected acoustic wave O₂ having passed only through the wall of the envelope 11, the second electric signal U₂ being a function of the difference in acoustic energy between the incident acoustic wave O₁ and the reflected acoustic wave O₂. In other words, unlike prior art which teaches to measure the acoustic attenuation in a fluid between the walls of the envelope 11, the present invention suggests to focus only on the acoustic attenuation of the wall of the envelope 11, that is, within the wall thickness. The reflected acoustic wave O₂ is received faster than in prior art and has a greater acoustic power, which facilitates its processing since it traveled a shorter distance. This significantly increases accuracy.

Unlike prior art which teaches to measure acoustic attenuation directly in a fluid, the present invention is directed to an indirect measurement by analyzing the acoustic attenuation of the wall of the envelope 11. Advantageously, the applicant has realized that the acoustic attenuation of the wall of the envelope 11 depends on the presence or absence of fluid on the inner face 14 of the wall. Advantageously, each transducer 22 is of the piezoelectric type and allows an electric signal to be converted into a mechanical stress (vibration) and vice versa. However, other types of transducers 22a-22g could of course be used, for example, PZT ceramics, PVDF polymers, etc. Preferably, the incident acoustic wave O₁ is a sinusoidal pulse.

Each transducer 22a-22g thus enables the acoustic attenuation between the incident wave O₁ and the reflected wave O₂ to be measured through the inner face 14 of the wall of the envelope 11.

As will be set forth later, the calculation member 23 is configured to determine, from the electric signals U₁-U₂ and the physical properties P₁-P₂ of the single-phase fluids F₁, F₂, the presence of the first single-phase fluid F₁ at each vertical height of the transducers 22a-22g and to deduce the fill level N_{R} therefrom.

The transducers 22a-22g are positioned at different vertical heights so as to detect the presence of the first single-phase fluid F₁ at different heights and thereby deduce the fill level N_{R} therefrom. Advantageously, the number of transducers 22a-22g is chosen as a function of the accuracy desired. The transducers 22a-22g are positioned in contact with the outer face 12 of the cylindrical portion 13 of the envelope 11 so as to optimally emit/receive into the wall of the envelope 11.

The control member 21 is in the form of a calculation unit configured to emit the first electric signal U₁ at predetermined times. For this purpose, the control member 21 comprises a clock.

In a similar manner, the calculation member 23 is in the form of a calculation unit configured to receive the second electric signal U₂ and to determine the time of reception. For this purpose, the calculation member 23 comprises a clock.

Preferably, the control member 21 and the calculation member 23 are integrated in a same calculation module, for example, an electronic board. Preferably, the calculation module comprises a battery for powering the control member 21, the calculation member 23 and the transducers 22.

Preferably, the measurement system 20 further comprises a communication unit for communicating, in a wired or wireless manner, the fill level N_{R} which has been determined. This is particularly advantageous when the measurement system comprises a signaling device as disclosed in patent application FR1871656.

Preferably, the measurement system 20 comprises a flexible support to which the transducers 22a-22g are mounted. This allows the transducers 22a-22g to be accurately positioned with respect to each other, thereby improving the accuracy of the measurement of the fill level N_{R}. Preferably, the flexible support is connected to the tank by bonding, magnetization, or the like.

The calculation member 23 is configured to determine the presence of the first single-phase fluid F₁ at each vertical height of the transducers 22a-22g from electric signals U₁, U₂ from each transducer 22a-22g. Thereafter, when a transducer 22a-22g detects the presence of the first single-phase fluid F₁, it is considered to be in a lower state ET₁, (presence of fluid) while it is considered to be in an upper state ET₂ otherwise (absence of fluid).

Thus, the calculation member 23 makes it possible to define a first group of transducers in the lower state ET₁, and a second group of transducers in the upper state ET₂. The calculation member 23 can thus conveniently and quickly deduce the interface height I at the interface between both groups of transducers. The height of interface I is higher than any transducer 22 in the lower state ET₁ (presence of fluid) and lower than any transducer 22 in the upper state ET₂ (absence of fluid). In this example, with reference to FIG. 4, transducers 22a-22d are in the lower state ET₁ while transducers 22e-22g are in the upper state ET₂. Thus, it can be deduced therefrom that the interface I is located between transducer 22d and transducer 22e and thus the fill level N_{R} can be determined.

In the first embodiment of FIG. 4, the tank 10 is oriented horizontally and the transducers 22a-22g are distributed on the half-circumference of the outer face 12 at the cylindrical median portion 13, in other words along a line curved in a plane transverse to the axis X10 of the tank 10. In this example, the calculation member 23 is configured to determine the presence of the first single-phase fluid F₁ as a function of acoustic attenuation.

Preferably, the transducers 22a-22g are advantageously equidistant from each other so that the fill level N_{R} of the tank 10 can be determined with an accuracy calibrated to the pitch of the transducers 22a-22g. The density of transducers 22 could of course be higher near certain critical fill levels.

In this example, the transducers 22a-22g are aligned along a single plane transverse to the axis X10 of the tank 10 but, of course, in a second configuration, they could extend along a plurality of transverse planes. In particular, the transducers 22a-22g may extend along two transverse planes spaced apart by the order of the size of a transducer 22a-22g and distributed in a staggered manner so that each transducer 22a-22g has a different vertical position. Such an arrangement is advantageous for possessing significant accuracy without being limited by the dimensions of a transducer 22a-22g. Thus, the accuracy can be higher than the size of the transducer 22a-22g.

As illustrated in FIGS. 4 and 5, for a horizontally oriented tank 10, each transducer 22a-22g is positioned along the tangent to the cylindrical median portion 13 so as to emit the incident wave O₁ and receive the reflected wave O₂ along a direction normal to the tangent to the positioning point of said transducer 22a-22g. As illustrated in FIG. 5, the reflected wave O₂ reflects primarily along the same direction as the incident wave O₁. Because the transducers 22 are at different vertical heights, the incident acoustic waves O₁ propagate in different parts of the tank 10.

Reflected acoustic waves O₂ are generated by reflection of the incident acoustic waves O₁ on the inner face 14 of the emission wall and propagate in an identical direction but reverse sense to that of the incident acoustic waves O₁ as illustrated in FIG. 4. The reflected acoustic wave O₂ can thus be conveniently received by the transducer 22 having emitted the incident acoustic wave O₁. Because of the proximity of the outer face 12 and the inner face 14, the propagation time is short and the measurement is accurate, as the misalignment between the incident acoustic wave O₁ and the reflected acoustic wave O₂ is small.

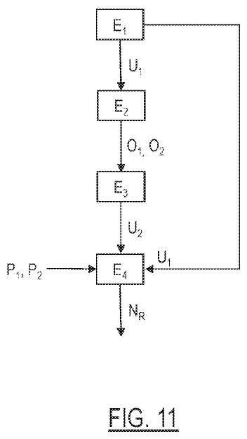

An example of an implementation of a method for measuring the fill level is shown in FIG. 11. The method comprises:
a step of emitting E₁ by each transducer 22 an incident acoustic wave O₁ to the outer face 12 of a wall of the envelope 11 following the reception of a first electric signal U₁,
a step of receiving E₂ a reflected acoustic wave O₂ by each transducer 22 generated by the reflection of the incident acoustic wave O₁ on the inner face 14 of said wall, the reflected acoustic wave O₂ having passed only through the wall of the envelope 11, the second electric signal U₂ being a function of the difference in acoustic energy between the incident acoustic wave O₁ and the reflected acoustic wave O₂
a step E₃ of determining the presence of the first single-phase fluid F₁ at each vertical height of the transducers 22 from the electric signals U₁, U₂ and the physical properties P₁, P₂ of the single-phase fluids F₁ F₂, in particular, by comparing the acoustic powers, and
a step of determining E₄ the fill level N_{R} as a function of the presence of the first single-phase fluid F₁ at each vertical height of the transducers 22.

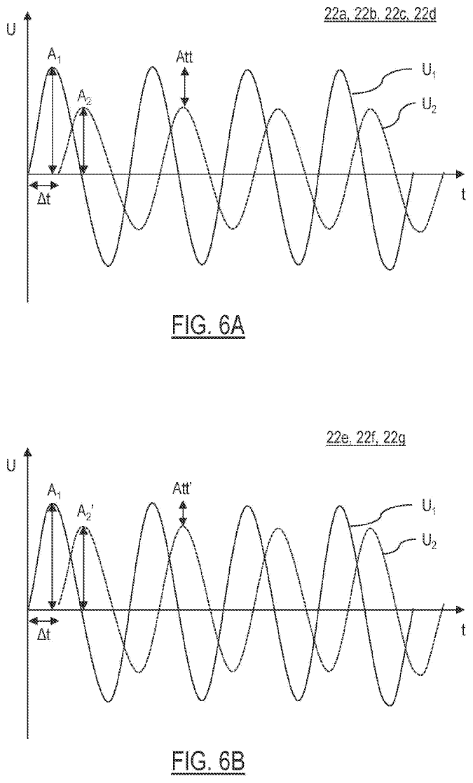

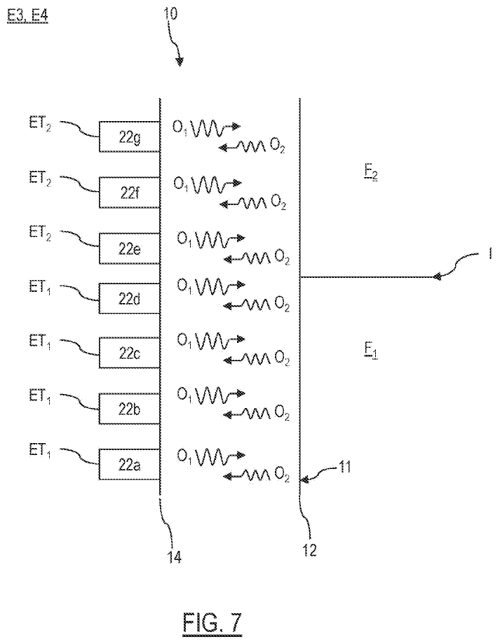

According to the invention, the incident acoustic waves O₁ propagate only in the wall of the envelope 11 in the direction normal to the plane tangent to the outer face 12. In other words, the incident acoustic waves O₁ propagate in the thickness of the wall of the envelope 11. The reflected acoustic waves O₂ are generated by the reflection of the incident acoustic waves O₁ on the inner face 14 of the wall of the envelope 11 and propagate in an identical direction but reverse sense to that of the incident acoustic waves O₁ as illustrated in FIG. 7. In this way, each reflected acoustic wave O₂ is generated by reflection on the inner face 14 in contact on the other side with only one of the single-phase fluids F₁, F₂. As a function of the single-phase fluid F₁, F₂ in contact with the inner face 14, acoustic energy of the reflected wave O₂ is different as illustrated in FIGS. 6A and 6B. To detect the relevant reflected acoustic wave O₂, it is sufficient to monitor the reflected wave O₂ that is received within a predetermined time interval Δt as illustrated in FIGS. 6A and 6B and measure its amplitude.

As an example, each transducer 22a-22g is a piezoelectric having a diameter of 10 mm, preferably between 5 mm and 20 mm. Each transducer 22a-22g has a frequency between 0.5 MHz and 2 MHz, preferably in the order of 1 MHz. The amplitude is between 1 and 50V, preferably in the order of 10V. Preferably, the emission steps are spaced from 10 to 100 ms, preferably, in the order of 20 ms.

As an example, with reference to FIG. 5, the acoustic energy of the reflected wave O₂ is smaller when the inner face 14 is in contact with the first single-phase fluid F₁ (FIG. 6A) than with the second single-phase fluid F₂ (FIG. 6B). Indeed, advantageously, the wall of the envelope 11 forms an energy filter that allows the presence of the first single-phase fluid F₁ with the inner face 14 to be characterized. Such a detection of the nature of the single-phase fluid directly at the measurement location allows to dispense with drawbacks related to the reflection in a transit time measurement through the whole tank.

The calculation member 23 makes it possible to determine the state ET₁/ET₂ of a transducer 22 from the difference in acoustic energy between the emission of the incident acoustic wave O₁ and reception of the reflected acoustic wave O₂ that it has received. In other words, the calculation member 23 determines the acoustic attenuation Att corresponding to the reflected energy divided by the incident energy as illustrated in FIGS. 6A and 6B. Indeed, the difference in acoustic power varies as a function of the single-phase fluid F₁, F₂ in contact with the inner face 14.

In practice, the calculation member 23 is configured to compare the difference in acoustic energy at each transducer 22 to a database comprising reference acoustic attenuations of the single-phase fluids F₁ F₂ for said tank 10.

In this example, the reference acoustic attenuations of the single-phase fluids F₁, F₂ are determined empirically or theoretically from the acoustic impedances Z₁, Z₂ of the single-phase fluids F₁, F₂, size of the tank 10, thickness of its envelope 11, nature of its envelope 11, etc. Preferably, during the installation of the measurement system 20, reference acoustic attenuations of the single-phase fluids F₁, F₂ are determined by the installer, for example, during a calibration phase.

More precisely, the state ET₁/ET₂ of a transducer 22 is determined from the amplitude attenuation of the reflected acoustic wave O₂ that it has received with respect to that of the incident acoustic wave O₁ that it has emitted. Indeed, when an acoustic wave is reflected on any interface, the fluid located on the other side of the interface absorbs part of the energy of the acoustic wave, which decreases its amplitude. The part of absorbed energy depends on the resistance of the fluid, that is its acoustic impedance, and differs for two different single-phase fluids.

In practice, the acoustic impedances Z₁, Z₂ of the single-phase fluids F₁, F₂ are calculated from the physical properties P₁, P₂ of the single-phase fluids F₁, F₂, that is, their theoretical densities ρ₁, ρ₂, their theoretical speeds of propagation V₁, V₂ and their temperatures T₁, T₂, measured in the tank 10. However, of course the acoustic impedances Z₁, Z₂ of the single-phase fluids F₁, F₂ can be obtained in a different way. In this example, the temperatures T₁, T₂ are measured by a temperature sensor and transmitted to the communication unit connected to the calculation member 23. Preferably, the step of determining the acoustic impedances Z₁, Z₂ is repeated periodically as the temperatures T₁, T₂ of the single-phase fluids F₁, F₂ change over time.

The acoustic attenuation is determined according to the following formula:

Att=(Z₂−Z₁)²/(Z₂+Z₁)² [Math. 1]

In practice, in the presence of a first single-phase fluid F₁ which is liquid, the reflected acoustic energy is in the order of 97%. Conversely, in the presence of a second single-phase fluid F₂ which is gaseous, the reflected acoustic energy is in the order of 99.8%.

Advantageously, the acoustic attenuation measured at the lowest positioned transducer 22a can be equated to the acoustic attenuation of the first single-phase fluid F₁. Similarly, the acoustic attenuation measured at the highest positioned transducer 22g can be equated to the acoustic attenuation of the second single-phase fluid F₂. These acoustic attenuations are obtained by a calibration step. Preferably, the calibration step is repeated periodically since the impedances are a function of the temperatures T₁, T₂ of the single-phase fluids F₁, F₂ which change over time.

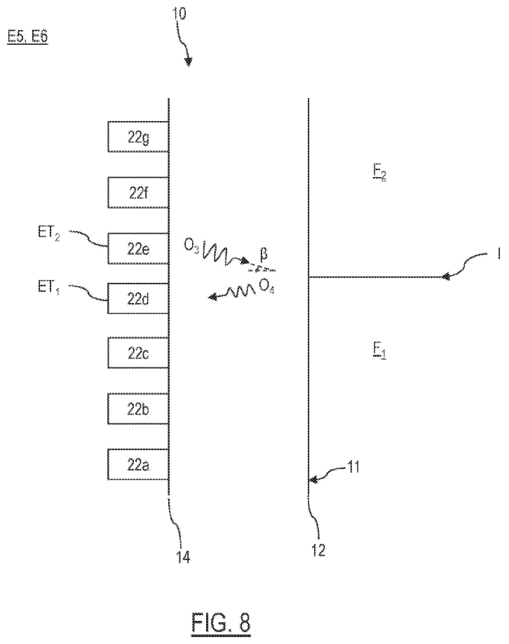

Preferably, the acoustic attenuation is calculated from the reflected energy received by the transducer having emitted the incident wave O₁. As illustrated in FIGS. 7 and 8, in order to increase accuracy, following the emission of an incident wave O₁ by a determined transducer 22, the reflected energy received by the transducer 22 located directly below the determined transducer 22 is also measured.

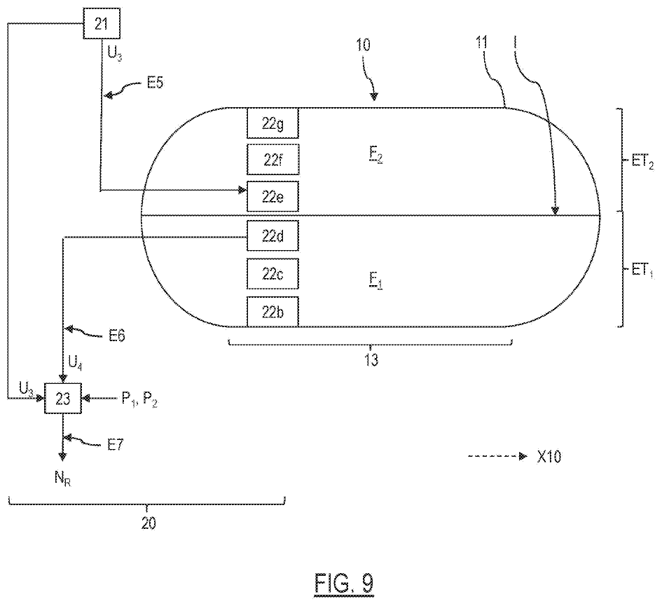

Still referring to FIGS. 7 and 8, at least one transducer 22e is configured to emit, further to the incident wave O₁ (FIG. 7), a complementary incident wave O₃ (FIG. 8) into the envelope 11 of the tank 10 following the reception of a third electric signal U₃ emitted by the control member 21. In this example, the curvature of the wall has been ignored for the sake of clarity. Of course the invention also applies to a curved wall. The trajectory of this complementary incident wave O₃ is oriented at a measurement angle β with respect to that of the incident acoustic wave O₁ (horizontal direction), so as to generate a complementary reflected acoustic wave O₄ which is received by an adjacent transducer 22d (located directly below). As illustrated in FIG. 9, this transducer 22d is in turn configured to emit a fourth electric signal U₄ to the calculation member 23, upon receiving the second reflected acoustic wave O₄. Similarly to previously, the calculation member 23 is configured to measure the acoustic attenuation at each transducer 22 (between the third electric signal U₃ and the fourth electric signal U₄) to a database comprising the reference acoustic attenuations of the single-phase fluids F₁, F₂ for said tank 10 and for said measurement angle β. Similarly, said reference acoustic attenuations of the single-phase fluids F₁, F₂ are determined empirically or theoretically.

Preferably, the measurement angle β is between 1° and 15° so as to allow the interface I to be accurately detected between two transducers 22e-22d having different states ET₁/ET₂. This advantageously allows to determine whether the fill level N_{R} is closer to the transducer 22d in the lower state ET₁, or to the transducer 22e in the higher state ET₂. In other words, the accuracy of measurement of the fill level N_{R} is increased by this additional measurement.

Advantageously, the measurement system 20 thus allows a double measurement of the fill level N_{R} of the tank 10, allowing a gain in both accuracy and reliability.

In other words, the reflected energy from an adjacent transducer is measured in order to more accurately determine the interface level I, in particular, when a transducer is located at the interface.

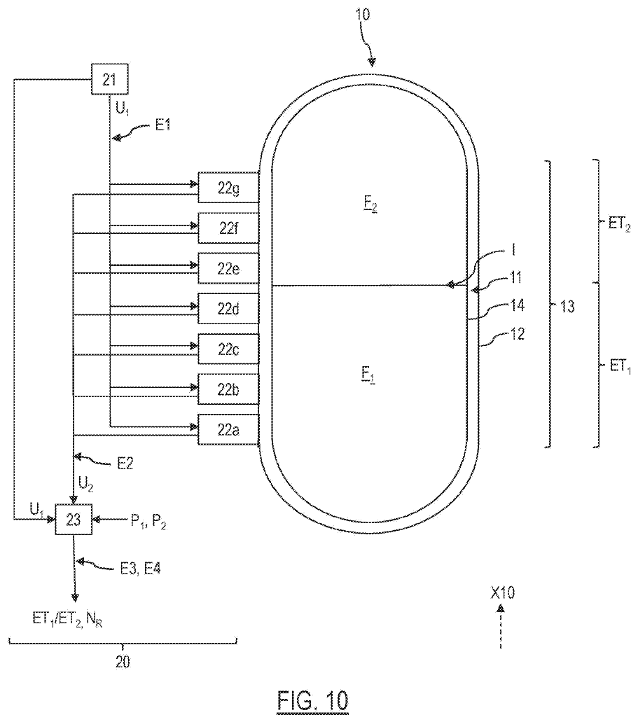

A horizontal tank with an acoustic energy attenuation measurement system has been set forth, but it is understood that such a measurement system 20 is adapted for a vertical tank 10 as illustrated in FIG. 10. In the case of a vertical tank 10, the transducers 22a-22g are distributed along the cylindrical median portion 13 along the length. Instead of being arranged along a curved line as in the case of a horizontal tank 10 described above, the transducers 22a-22g are positioned along a vertical rectilinear line, parallel to the axis X10 of the vertical tank 10.

As in the case of a horizontal tank 10, of course the transducers 22a-22g may be positioned along a plurality of vertical rectilinear lines, in particular two vertical rectilinear lines spaced apart in the order of one transducer 22a-22g and distributed in a staggered pattern. This has the advantage of being able to arrange a greater number of transducers 22a-22g closer together and thus of increasing accuracy of the measurement.

1-11. (canceled)

12. An acoustic wave measurement system for measuring the fill level of a tank, said tank storing a first single-phase fluid having first physical properties and a second single-phase fluid having second physical properties, said first physical properties comprising a first density ρ₁ and said second physical properties comprising a second density ρ₂ strictly lower than the first density ρ₁ so that the single-phase fluids are vertically superimposed in the tank, the first single-phase fluid being located in the lower part of the tank, the second single-phase fluid being located in the upper part of the tank, said first single-phase fluid and said second single-phase fluid being separated by a substantially horizontal interface, said tank comprising an envelope extending longitudinally along an axis X10, the envelope comprising an inner face in contact with the single-phase fluids and an outer face, the envelope comprising a cylindrical median portion, wherein the measurement system comprises:
at least three transducers configured to be positioned at different vertical heights on the outer face of the cylindrical portion of the envelope,
each transducer being configured, on the one hand, to emit, upon receiving a first electric signal, an incident acoustic wave to the outer face of a wall of the envelope and, on the other hand, to emit a second electric signal, upon receiving a reflected acoustic wave, corresponding to the reflection of the incident acoustic wave on the inner face of said wall, the reflected acoustic wave having passed only through the wall of the envelope, the second electric signal being a function of the difference in acoustic energy between the incident acoustic wave and the reflected acoustic wave,
at least one calculation member configured to determine, from the electric signals and physical properties of the single-phase fluids, the presence of the first single-phase fluid at each vertical height of the transducers and to deduce the fill level therefrom.

13. The measurement system according to claim 12, wherein the transducers are aligned along a line in a vertical plane.

14. The measurement system according to claim 13, wherein the transducers are aligned along a rectilinear line.

15. The measurement system according to claim 12, wherein the transducers are configured to emit horizontal incident acoustic waves.

16. The measurement system according to claim 12, wherein the difference in acoustic energy is determined from acoustic impedances of the single-phase fluids.

17. The measurement system according to claim 12, wherein the calculation member is configured to compare the electric signals to a database comprising reference acoustic attenuations of the single-phase fluids for said tank to determine the presence of the first single-phase fluid at each vertical height of the transducers.

18. The measurement system according to claim 12, wherein, with the calculation member being configured to determine, for each transducer, a lower state in the presence of the first single-phase fluid or an upper state in the absence of the first single-phase fluid, the calculation member is configured to determine the height of the interface from the height of the two successive transducers, one of which is in a lower state and the other in an upper state.

19. The measurement system according to claim 12, wherein the transducers are configured to emit, further to the incident wave, a complementary incident wave in the wall of the envelope of the tank, the trajectory of this complementary incident wave being oriented by a measurement angle with respect to that of the incident acoustic wave so as to generate a complementary reflected acoustic wave which is received by a transducer adjacent to the transducer having emitted the incident waves.

20. The measurement system according to claim 12, wherein the calculation member is configured to measure the acoustic attenuation at each transducer to a database comprising reference acoustic attenuations of the single-phase fluids for said tank and for said measurement angle.

21. An assembly of a tank and the measurement system according to claim 12.

22. An acoustic wave measurement method for measuring the fill level of a tank,
implemented by means of the measurement system according to claim 12, the method comprising:
a step of emitting by each transducer an incident acoustic wave to the outer face of a wall of the envelope following the reception of a first electric signal,
a step of receiving a reflected acoustic wave by each transducer, generated by the reflection of the incident acoustic wave on the inner face of said wall, the reflected acoustic wave having passed only through the wall of the envelope, the second electric signal being a function of the difference in acoustic energy between the incident acoustic wave and the reflected acoustic wave,
a step of determining the presence of the first single-phase fluid at each vertical height of the transducers from the electric signals and the physical properties of the single-phase fluids, and
a step of determining the fill level as a function of the presence of the first single-phase fluid at each vertical height of the transducers.
